(19) United States
(12) Patent Application Publication
(10) Pub. No.: US 2004/0083487 A1
(43) Pub. Date: Apr. 29, 2004

(54) Content and key distribution system for digital content representing media streams

(75) Inventors: Daniel A. Collens, Waterloo (CA); Stephen Watson, Toronto (CA); Michael A. Malcolm, Aspen, CO (US)

Correspondence Address: SWERNOFSKY LAW GROUP PC, P.O. BOX 390013, MOUNTAIN VIEW, CA, 94039-0013, US

(73) Assignee: Kaleidescape, a corporation, Mountain View, CA

(21) Appl. No.: 10/616,698

(22) Filed: Jul. 9, 2003

Related U.S. Application Data
(63) Continuation of application No. 10/356,692, filed on Jan. 31, 2003.
(63) Continuation of application No. 10/377,266, filed on Feb. 28, 2003.
(63) Continuation of application No. 10/378,046, filed on Feb. 28, 2003.
(63) Continuation of application No. 10/616,899, filed on Jul. 9, 2003.
(60) Provisional application No. 60/394,630, filed on Jul. 9, 2002.
(60) Provisional application No. 60/394,922, filed on Jul. 9, 2002.
(60) Provisional application No. 60/394,588, filed on Jul. 9, 2002.

(51) Int. Cl. H04N 7/167; B62K 21/00; B62K 17/00; B62M 15/00; B62M 13/00; B62M 11/00; B62M 9/00; B62M 7/00; B62M 5/00; B62M 3/00; B62K 1/00; H04N 7/16; H04L 9/00; H04K 1/00

(52) U.S. Cl. 725/31; 725/30; 380/210; 380/255; 280/278; 380/28

(57) ABSTRACT

A technique of distributing digital content representing media streams, and keys for unlocking that content, to a user. Content is deliverable to the user separately from licenses to that content. Content is delivered encrypted. Licenses are delivered designating selected presentation devices owned by the user. The presentation devices include a secure portion, relatively resistant to tampering by the user, in which each presentation device maintains a unique presentation device key. The user owns one or more such presentation devices, coupled using a local communication link to a local library, which maintains a copy of the content in an encrypted form. The user can search the library for information generally available about the media stream.

### BACKGROUND OF THE INVENTION

1. Field of the Invention

The invention relates to distributing content and keys for digital content representing media streams.

2. Related Art

Distribution of digital content representing media streams, such as for example movies, is subject to several problems. One problem is that it is easy to make exact copies of digital content, thus allowing any recipient of that content to redistribute it, whether authorized or not. It would be advantageous to be able to distribute digital content, particularly digital content representing media streams, without fear of its unauthorized distribution. This would be particularly advantageous when it is desired to distribute digital content using a communication link, such as for example a computer network or other technique for distribution to end viewers (for example, either on demand, in anticipation of future demand, or in response to something else).

One known solution is to encrypt the digital content to be used for presentation as media streams, so that a recipient of that digital content cannot easily redistribute it to unauthorized recipients. It would be advantageous to ensure that encryption protects the content all the way from its source to the presentation device at which it is to be presented to a user. However, if there is more than one presentation device owned by the user, that known solution involves either delivering the content separately for each presentation device, or allowing the content to remain in an unencrypted form (herein also called “in the clear”) at some location on some device controlled by the user.

In a related invention, manipulation of digital content by recipients is restricted to a secure portion of a playback device, so that recipients cannot distribute that digital content for purposes other than presentation to viewers. It would be advantageous to further restrict manipulation of digital content so that presentation to viewers could only occur within limits imposed by licensing restrictions. For example, some movies are distributed with a specified release date, that is, a date upon which they become available for release to the public for presentation, and not before. It would also be advantageous, especially in a networked system for distribution of digital content representing media streams, to be able to distribute digital content without fear that recipients would present the media streams represented by that digital content earlier than allowed.

Accordingly, it would be advantageous to provide an improved technique for distribution of digital content.

### SUMMARY OF THE INVENTION

The invention provides a method and system capable of distributing digital content representing media streams, and keys for unlocking (such as for example decrypting) that content, to a user. In one aspect, the invention provides for content to be deliverable to the user separately (either by a different communication, or separately in time, either earlier or later) from licenses to that content. The content is delivered encrypted, with the effect that the user cannot redistribute that content. The licenses are delivered designating selected presentation devices owned by the user (in one embodiment, each license is associated with exactly one such presentation device), with the effect that the user cannot present that content on unlicensed presentation devices, and with the effect that the content need only be delivered to the user once for more than one presentation device.

In one embodiment, the presentation devices include a secure portion, relatively resistant to tampering by the user, in which each presentation device maintains a unique presentation device key, with the effect that licenses can be tailored to selected presentation devices. For one example, not intended to be limiting in any way, the secure portion might be implemented in an application-specific hardware device, the hardware device being resistant to intrusion on any of its communication paths and not allowing the presentation device key or the digital content to be seen by the user. (In such embodiments, the presentation device key and the digital content is not available outside the specific integrated circuit implementing the secure portion of the presentation device, the specific integrated circuit being bonded by epoxy to its board and relatively hardware resistant to either tampering or snooping.) The user owns one or more such presentation devices, coupled using a local communication link to a local library, which maintains a copy of the content in an encrypted form, with the effect that the user cannot redistribute the digital content in the clear, and with the effect that that user cannot present the media stream represented by that digital content without an appropriate license (the license designating the selected presentation device, in one embodiment by itself being encrypted using the selected presentation device key). However, the user can search the library for information generally available about the media stream, such as for example embedded in metadata for the digital content, without having to substantially decrypt that digital content.

The invention is not restricted to movies, but is also applicable to other media streams, such as for example animation or sound, as well as to still media, such as for example pictures or illustrations, and to databases and other collections of information.

### BRIEF DESCRIPTION OF THE DRAWINGS

FIG. 1 shows a block diagram of a system for distributing content and keys for digital content representing media streams.

FIGS. 2A and 2B show flow diagrams of a method for distributing content and keys for digital content representing media streams.

### INCORPORATED DISCLOSURES

This application claims priority of the following documents, each of which is hereby incorporated by reference as if fully set forth herein.

U.S. provisional patent application 60/394,630, filed Jul. 9, 2002, in the name of Michael Malcolm, Stephen Watson, Daniel Collens, and Kevin Hui, attorney docket number 217.1001.01, titled “Watermarking and Fingerprinting a Movie for Secure Distribution.”

U.S. provisional patent application 60/394,922, filed Jul. 9, 2002, in the name of Michael Malcolm, Stephen Watson, and Daniel Collens, attorney docket number 217.1002.01, titled “System Architecture of a System for Secure Distribution of Media.”

U.S. provisional patent application 60/394,588, filed Jul. 9, 2002, in the name of Michael Malcolm, Stephen Watson, and Daniel Collens, attorney docket number 217.1003.01, titled “Topology of Caching Nodes in a System for Secure Delivery of Media Content.”

U.S. patent application Ser. No. 10/356,692, filed Jan. 31, 2003, in the name of Daniel Collens, Stephen Watson, and Michael Malcolm, attorney docket number 217.1004.01, titled “Parallel Distribution and Fingerprinting of Digital Content”.

U.S. patent application Ser. No. 10/356,322, filed Jan. 31, 2003, in the name of Stephen Watson, Daniel Collens, and Kevin Hui, attorney docket number 217.1005.01, titled “Watermarking and Fingerprinting Digital Content Using Alternative Blocks to Embed Information”.

U.S. patent application Ser. No. 10/377,266, filed Feb. 28, 2003, in the name of Stephen Watson, attorney docket number 217.1006.01, titled “Recovering from De-Synchronization Attacks Against Watermarking and Fingerprinting”.

U.S. patent application Ser. No. 10/378,046, filed Feb. 28, 2003, in the name of Stephen Watson, attorney docket number 217.1007.01, titled “Detecting Collusion Among Multiple Recipients of Fingerprinted Information”.

U.S. patent application Ser. No. 10/______, filed this same day, in the name of Michael MALCOLM, Daniel COLLENS, Stephen WATSON, Paul RECHSTEINER, Kevin HUI, attorney docket number 217.1008.01, titled “Secure Presentation Of Media Streams in Response to Encrypted Digital Content”.

These documents are hereby incorporated by reference as if fully set forth herein, and are sometimes referred to herein as the “incorporated disclosure”.

Inventions described herein can be used in combination or conjunction with technology described in the incorporated disclosure.

### DETAILED DESCRIPTION OF THE PREFERRED EMBODIMENT

In the description herein, a preferred embodiment of the invention is described, including preferred process steps and data structures. Those skilled in the art would realize, after perusal of this application, that embodiments of the invention might be implemented using a variety of other techniques not specifically described, without undue experimentation or further invention, and that such other techniques would be within the scope and spirit of the invention.

Lexicography

The general meaning of each of these following terms is intended to be illustrative and in no way limiting.

The phrase “media stream” describes information intended for presentation in a sequence, such as motion pictures including a sequence of frames or fields, or such as audio including a sequence of sounds. As used herein, the phrase “media stream” has a broader meaning than the standard meaning for “streaming media,” (of sound and pictures that are transmitted continuously using packets and that start to play before all of the content arrives). Rather, as described herein, there is no particular requirement that media streams must be delivered continuously. Also as described herein, media streams can refer to other information for presentation, such as for example animation or sound, as well as to still media, such as for example pictures or illustrations, and also to databases and other collections of information.

The phrase “digital content” describes data in a digital format, intended to represent media streams or other information for presentation to an end viewer. “Digital content” is distinguished from packaging information, such as for example message header information. For the two phrases “digital content” and “media stream,” the former describes a selected encoding of the latter, while the latter describes a result of presenting any encoding thereof.

The phrase “end viewer,” and the term “user,” describe a recipient of the media streams for whom decoding of the digital content for the media streams, and presentation of the media streams, is contemplated.

The term “decoding” describes generating data in a form for presentation of the media streams, in response to the digital content for the media streams in an encoded format. As described herein, the encoded format might include an industry standard encoded format such as MPEG-2. However, the concept of decoding as described herein is sufficiently general to include other encoding formats for media streams.

The term “presentation” describes generating information in a form for viewing of the media streams, such as for example audio and visual information for viewing a movie. As described herein, presentation of a movie might include visual display of the frames or fields of motion picture, as well as audio presentation of a soundtrack associated with that motion picture. However, the concept of presentation as described herein is sufficiently general to include a wide variety of other forms of generating information for viewing.

The phrase “licensing restrictions” describes any business rules having an effect on use of the media streams or the digital content representing those media streams. Examples of licensing restrictions include, without limitation, legal or contractual limits to use by an end viewer, such as for example any limits to use responsive to selected dates or times or categories thereof, limitations to selected playback elements or categories thereof, selected locations (such as for example selected countries or cities), selected end viewers or categories thereof, a selected number of times (or a selected range of number of times), a selected type of payment, additional fingerprinting for presentation, or other business rules or categories thereof.

The phrase “presentation device” describes any software or hardware element, or software and hardware elements operating in combination or conjunction, capable of decoding the digital content and presenting the media streams to an end viewer in a human-perceivable form. Examples of presentation devices include, without limitation, an MPEG decoder coupled with a television monitor and speaker. As described herein, in one embodiment the presentation device includes both a secure portion, capable of decoding the digital content, and a non-secure portion, capable of presenting the decoded digital content in a human-perceivable form to the end viewer. After reading this application, those skilled in the art will recognize that there are many configurations of presentation device within the scope and spirit of the invention. For a first example, a presentation device might include a single integrated device in which the operation of the whole device is made relatively inaccessible to the user. For a second example, a presentation device might include a common secure portion and more than one display element (such as for example a flat panel display, speakers, or both) receiving its inputs from that common secure portion. For a third example, a presentation device might include a sophisticated rendering system that translates MPEG encoding into a 3D total-immersion presentation (such as for example a flight simulator), or an Artificial Intelligence system that watches the MPEG encoding for selected objects of interest (such as for example a surveillance review system). In the context of the invention, there is no particular requirement that presentation devices are limited in any way; presentation devices ultimately respond to the media stream represented by the digital content.

The term “secure” describes an aspect or element of an embodiment of the invention that is relatively reliable and trustworthy, as contrasted with “non-secure” aspects or elements, which might have been altered, compromised, tampered with, or otherwise suborned. The phrase “hardware secure” (or a “hardware level of security”) describes an aspect or element of an embodiment of the invention that would require tampering with hardware by the end viewer to make that aspect or element non-secure. The phrase “software secure” (or a “software level of security”) describes an aspect or element of an embodiment of the invention that would require tampering with software by the end viewer to make that aspect or element non-secure. The phrase “cryptographically secure” (or a “cryptographic level of security”) describes an aspect or element of an embodiment of the invention that would require defeating a cryptographic code, or other mathematical construct involving a similar degree of effort or luck, to make that aspect or element non-secure.

The phrase “secure portion” describes a portion of the presentation device comparatively secure against attack by an end viewer having physical control over the presentation device. In one embodiment, secure portions of presentation devices include, without limitation, a hardware element that has been isolated and protected against tampering by the end viewer. Examples of secure portions include hardware elements disposed so that the end viewer's effort to compromise security of the secure portion would be much more difficult than any economic value that might be achieved thereby. In one embodiment, the secure portion includes a secure clock.

Other and further applications of the invention, including extensions of these terms and concepts, would be clear to those of ordinary skill in the art after purchasing this application. These other and further applications are part of the scope and spirit of the invention, and would be clear to those of ordinary skill in the art without further invention or undue experimentation.

The scope and spirit of the invention is not limited to any of these definitions, or to specific examples mentioned therein, but is intended to include the most general concepts embodied by these and other terms.

System Elements

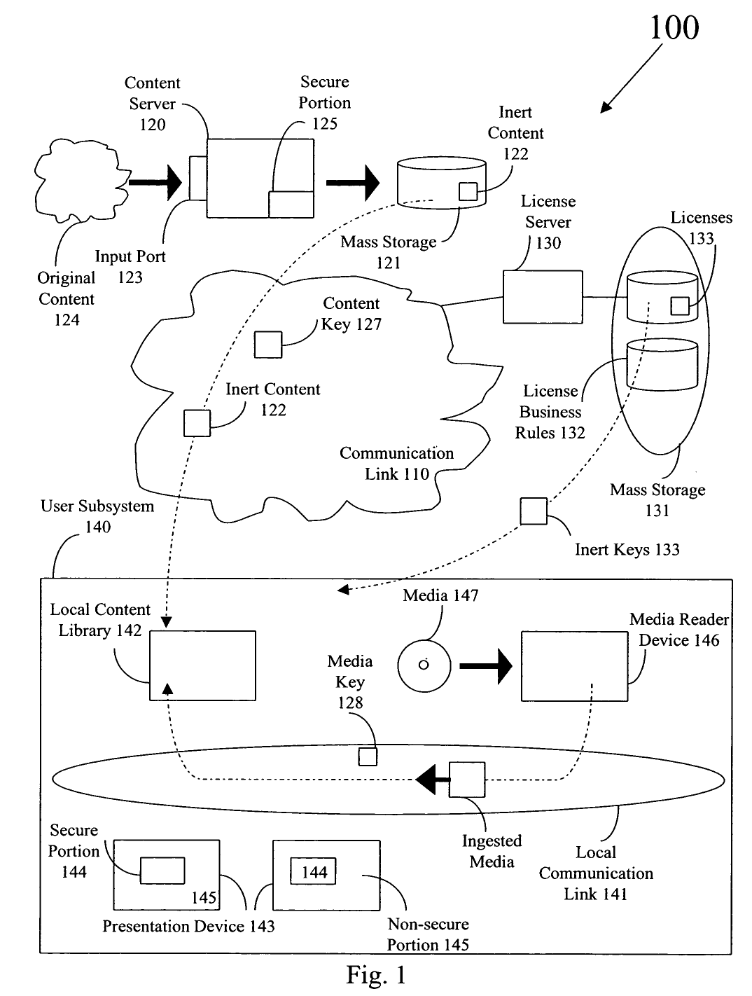

FIG. 1 shows a block diagram of a system for distributing content and keys for digital content representing media streams.

A system 100 includes a communication link 110, a content server 120, a license server 130, and a user subsystem 140.

The communication link 110 includes any technique capable of delivering digital content and licenses from senders to receivers, and in one embodiment, includes a computer network such as for example the Internet. In such embodiments, the content server 120 or the license server 130 might be coupled to the user subsystem 140 using one or more intermediate caching devices, such as for example shown in the incorporated disclosure.

The content server 120 includes a processor, program and data memory, and memory or mass storage 121 capable of maintaining inert content 122 over a substantial time period. The content server 120 includes an input port 123, capable of receiving original content 124 “in the clear” and includes software instructions capable of being interpreted by the processor to convert that original content 124 into inert content 122 maintainable in the storage 121. In one embodiment, a secure portion 125 of the content server 120 (or other location where original content 124 is received “in the clear”) is isolated from non-secure portions of the content server 120 and is secured against entry, tampering and inspection by unauthorized parties, with the effect that the original content 124 is made secure against accidental or malicious release. The original content 124 is streamed through that secure portion 125 of the content server 120, encrypted or re-encrypted as described below, and thus converted into inert content 122. However, the portion of the content server 120 where inert content 122 is maintained might be the non-secure portions of the content server 120.

The license server 130 includes a processor, program and data memory, and memory or mass storage 131 capable of maintaining a set of licensing business rules 132 and a set of licenses 133, with the effect that the license server 130 is capable of sending licenses 133 (those licenses 133 including user content keys 127, and being locked using presentation device keys 134) to a selected user subsystem 140. In one embodiment, similar to the secure portion 125 of the content server 120, a secure portion 135 of the license server 130 (or other location where licenses 133 are generated “in the clear”) is isolated from non-secure portions of the license server 130 and is secured against entry, tampering and inspection by unauthorized parties, with the effect that the licenses 133 are made secure against accidental or malicious release. However, the portion of the license server 130 where inert licenses 133 are maintained might be the non-secure portions of the license server 130.

Although described as separate devices, in the context of the invention there is no particular requirement that the content server 120 and the license server 130 be separate devices, or even that they be isolated subsystems part of the same device. Rather, the content server 120 and the license server 130 are described herein as separate devices to illustrate the different functions each performs. In one embodiment, the content server 120 and the license server 130 might be collocated at a single hardware device, using software appropriate to the processes and data structures described herein.

The user subsystem 140 includes a local communication link 141, a local content library 142, one or more presentation devices 143, each having a secure portion 144 and a non-secure portion 145, and a media reader device 146, such as for example a DVD reader capable of reading media 147 such as for example one or more DVD's.

Method of Operation

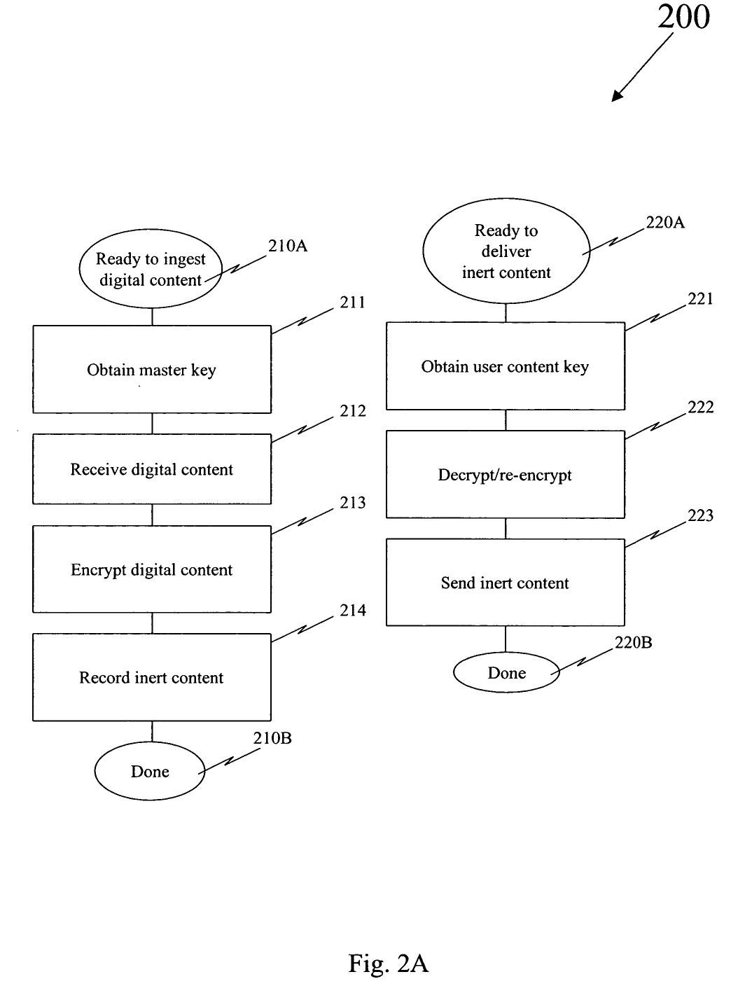

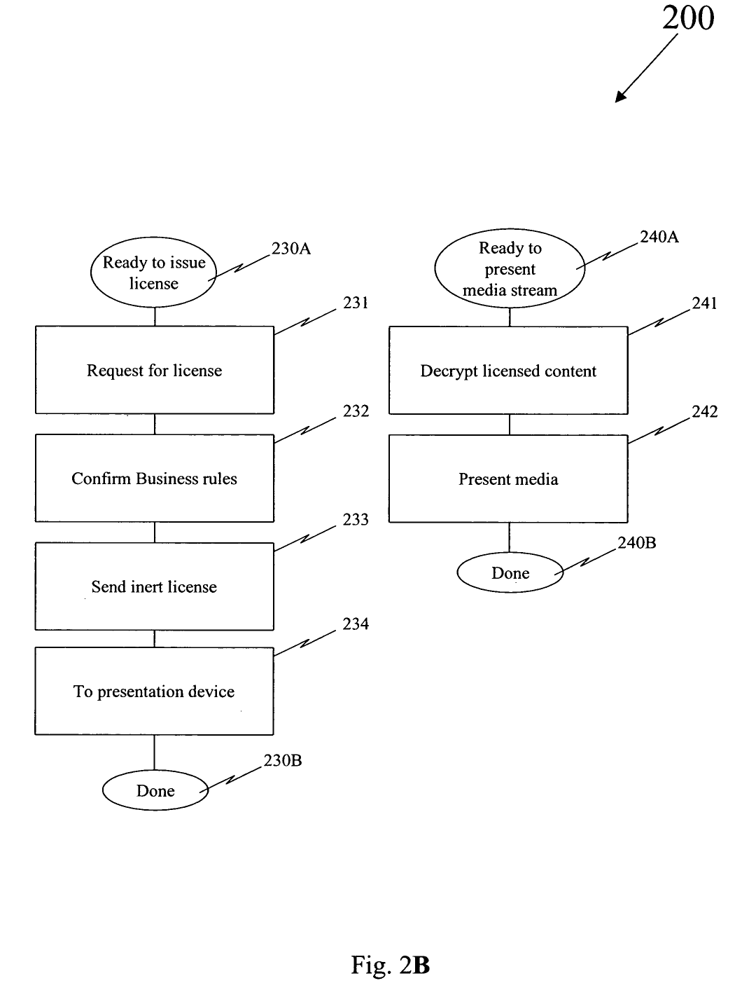

FIG. 2 shows a flow diagram of a method for distributing content and keys for digital content representing media streams.

Although described serially, the flow points and method steps of the method 200 can be performed by separate elements in conjunction or in parallel, whether asynchronously or synchronously, in a pipelined manner, or otherwise. In the context of the invention, there is no particular requirement that the method must be performed in the same order in which this description lists flow points or method steps, except where explicitly so stated.

Ingesting Digital Content

At a flow point 210A, the system 100 is ready to ingest original digital content 124 representing media streams.

At a step 211, the license server 130 obtains a master content key 126 for the original digital content 124, and sends that master content key 126 to the secure portion 125 of the content server 120. In one embodiment, keys are generated at a secure device in a secure location, such as a specialized key server (not shown) with which communication is conducted using only secure channels (such as for example SSL). In such embodiments, the key server might include a non-secure portion in which inert keys are maintained. Inert keys might include master content keys, user content keys, presentation device keys, or other keys, so long as those keys are locked against unauthorized inspection or tampering (such as by being encrypted using a master key). If the content server 120 and the license server 130 are collocated, the steps for sending are just that much simpler.

At a step 212, the secure portion 125 of the content server 120 receives the original digital content 124 “in the clear” representing media streams at its input port 123.

At a step 213, the secure portion 125 of the content server 120 encrypts the original digital content 124 with the master content key 126, with the effect of generating a set of inert content 122, and destroys any copies of the original digital content 124 it has “in the clear.”

At a step 214, the non-secure portion of the content server 120 records and maintains the inert content 122 in the storage 121. As part of this step, the content server 120 provides that the inert content 122 can be retrieved from the storage 121 in response to metadata regarding the original digital content 124, such as for example a title or serial number of the media stream.

At a flow point 210B, the system 100 has completed ingesting the original digital content 124, and is ready to ingest further original digital content 124, or to distribute inert content 122 to user subsystems 140, or to do something else.

Delivering Inert Content

At a flow point 220A, the system 100 is ready to deliver inert content 122 to one or more user subsystems 140.

At a step 221, the secure portion 125 of the content server 120 obtains a user content key 127 specific to the selected user subsystem 140. As described above, a secure key server generates keys; the secure portion 125 of the content server 120 obtains the user content key 127 from the key server using a secure communication link.

At a step 222, the secure portion 125 of the content server 120 decrypts the inert content 122 using its master content key 126 (unique to that particular item of digital content), and re-encrypts it using the specific user content key 127. As described above, a secure key server generates keys; in one embodiment, a non-secure portion of that key server maintains the specific user content key 127, associated with its user sub-system 140. This has the effect of generating a version of the inert content 122 specific to the selected user subsystem 140.

At a step 223, the non-secure portion of the content server 120 packages the specific version of the inert content 122 in an appropriate format, and sends that specific version of the inert content 122 to the local content library 142 at the selected user subsystem 140.

In embodiments of the invention, the inert content 122 might be delivered by sending it using one or more communication protocols using the communication link 110, or might be delivered to the user subsystem 140 by pre-loading that inert content 122 onto the local content library 142 when the user subsystem 140 is physically delivered or constructed, or might be delivered on physical media such as for example a DVD. For one example, not intended to be limiting in any way, the user might obtain a DVD having inert content 122 at a retail distribution point (such as for example a video store), where on that DVD are one or more media streams each encoded and encrypted to provide inert content 122.

In cases where the user obtains the inert content 122 by having it pre-loaded on the user subsystem 140, the inert content 122 on the user subsystem 140 has already been so re-encrypted.

In cases where the user obtains the inert content 122 using physical media, the content server 120 prepares the physical media using a media content key 128 specific to the selected physical media. The user is able to use the physical media as described below with regard to “Ingesting Physical Media.”

At a flow point 220B, the system 100 has delivered inert content 122 to one or more user subsystems 140, and is ready to issue a license 133 designating a selected presentation device 143, or to do something else.

Issuing License

At a flow point 230A, the system 100 is ready to issue a license 133 (specific to a selected item of digital content) designating a selected presentation device 143 to the associated user subsystem 140.

At a step 231, the license server 130 receives a request for a license 133 from the user subsystem 140 associated with the selected presentation device 143. In alternative embodiments, there need not be a specific request, and in addition or instead the license server 130 might be made aware of a set of subscriptions by known users to selected media streams (such as for example a periodical including audiovisual elements, or a bulk license including pre-purchase of selected content). In such embodiments, the license server 130 need not receive a specific request, but in addition or instead initiates the method 200 at the flow point 230 and skips this step.

At a step 232, the license server 130 confirms that the request conforms to the licensing business rules 132 as maintained at the license server 130. As noted with regard to the previous step, in embodiments where the license server 130 is made aware of subscriptions or pre-purchases, the license server 130 might be able to skip this step. Examples of licensing business rules 132 might include one or more of, or some combination or conjunction of, the following:

a release date for the media stream;

a final showing date for the media stream;

one or more “blackout” periods for the media stream;

geographic or other regional restrictions on presentation of the media stream (such as for example a version of the media stream licensed only for use in Europe, or only for use outside selected countries where that media stream is prohibited);

financial or other prerequisites for presentation of the media stream (such as for example a charge for viewing, or a requirement of having a nondisclosure agreement on file, or a requirement of a selected authorization within a company).

At a step 233, the license server 130 generates and sends an inert license 133 specific to the presentation device 143. To perform this step, the license server 130 performs the following sub-steps:

At a sub-step 233(a), the secure portion 135 of the license server 130 obtains the specific user content key 127 from the key server (as described above, the key server might maintain keys in a non-secure portion thereof), or obtains the specific media content key 128 from the user subsystem 140, as appropriate. Although in one embodiment, the user content key 127 is associated with a specific user, there is no particular requirement that this association be strictly maintained. For a first example, a user content key 127 might be assigned ahead of knowing which user it is associated with, similar to a warehouse receipt, which might be passed around before being affixed to a particular user. (This example might be useful in cases where it is desired to resell the user subsystem 140, such as for example when the owner is an installer or a video store.) For a second example, a user content key 127 might be associated with an organization, and thus be associated with different actual users within that organization from time to time. For a third example, a user content key 127 might be associated with a (typically relatively small) group of actual users, such as for example a family, a social club, or a cooperative.

At a sub-step 233(b), the secure portion 135 of the license server 130 generates a license 133 “in the clear.” As part of this sub-step, the secure portion 135 of the license server 130 inserts the specific conditions associated with the license 133, and the specific user content key 127, into the information package included in the license 133.

At a sub-step 233(c), the secure portion 135 of the license server 130 obtains the presentation device key 134 from the key server (as described above, the key server might maintain keys in a non-secure portion thereof).

At a sub-step 233(d), the secure portion 135 of the license server 130 encrypts the license 133 with the presentation device key 134, and destroys any copies of the license 133 “in the clear,” as well as any copies it has of the presentation device key 134. As described above, an inert copy of the presentation device key 134 remains maintained by the non-secure portion of the key server. This has the effect of generating an inert license 133 for the presentation device 143.

At a sub-step 233(e), the non-secure portion of the license server 130 packages the inert license 133 for the presentation device 143 in an appropriate format, and sends that inert license 133 to the local content library 142 at the selected user subsystem 140.

At a step 234, the local content library 142 at the user subsystem 140 sends the inert license 133 to the specific presentation device 143. In one embodiment, the specific presentation device 143 might actively request the inert license 133 from the local content library 142. However, in alternative embodiments, the local content library 142 might deliver the inert license 133 to the specific presentation device 143 using a “push” model or a subscription model for delivery of such information.

At a flow point 230B, the system 100 has issued a license 133 (specific to a selected item of digital content) designating a selected presentation device 143 to the associated user subsystem 140, and the user subsystem 140 is ready to present the media stream at a selected presentation device 143, or to do something else.

Presenting Media Stream

At a flow point 240A, the system 100 is ready to present the media stream at a selected presentation device 143.

At a step 241, the secure portion 144 of the presentation device 143 decrypts the inert license 133 and the inert content 122 for presentation to the user. To perform this step, the secure portion 144 of the presentation device 143 performs the following sub-steps:

At a sub-step 241(a), the secure portion 144 of the presentation device 143 decrypts the inert license 133 with its presentation device key 134.

At a sub-step 241(b), the secure portion 144 of the presentation device 143 checks the decrypted license 133 against a license integrity code maintained within that license 133. This has the effect of determining if the license 133 has been tampered with. Tampered-with licenses 133 are not valid.

At a sub-step 241(c), the secure portion 144 of the presentation device 143 obtains the user content key 127, or the media content key 128, as appropriate, from the license 133.

At a sub-step 241(d), the secure portion 144 of the presentation device 143 checks the license 133 for any restrictions it can enforce (such as for example a restriction to a selected time window), and if it finds any, enforces them. This might have the effect that the secure portion 144 of the presentation device 143 generates a signal indicating that the license 133 is not currently valid, and in one embodiment, why. If the license 133 is not currently valid, the secure portion 144 of the presentation device 143 refuses to present the media stream. If the license 133 is currently valid, the secure portion 144 of the presentation device 143 continues with the next sub-step.

At a sub-step 241(e), the secure portion 144 of the presentation device 143 decrypts the inert content 122 using the user content key 127, or the media content key 128, as appropriate, and streams the digital content to hardware in the presentation device 143 for presenting the media stream to the user.

At a step 242, the presentation device 143 presents the media stream to the user.

At a flow point 240B, the system 100 has presented the media stream at a selected presentation device 143, and is ready to do something else.

Ingesting Physical Media

At a flow point 250A, the user subsystem 140 is ready to ingest physical media 147 using a media reader 146.

At a step 251, the user subsystem 140 requests a license 133 to ingest the physical media 147 from the license server 130. In response, the license server 130 generates an inert license 133 to ingest the physical media 147 and sends that license 133 to the user subsystem 140.

At a step 252, the local content library 142 maintains the inert license 133 to ingest the physical media 147 in memory or storage.

At a step 253, the local content library 142 sends the inert license 133 to ingest the physical media 147 to the media reader 146.

At a step 254, the media reader 146 ingests the physical media 147. To perform this step, the media reader 146 performs the following sub-steps:

At a sub-step 254(a), similar to the sub-step 241(a), the media reader 146 decrypts the inert license 133 with its reader device key 134 (similar to a presentation device key 134).

At a sub-step 254(b), similar to the sub-step 241(b), the media reader 146 checks the decrypted license 133 against a license integrity code maintained within that license 133. This has the effect of determining if the license 133 has been tampered with. Tampered-with licenses 133 are not valid.

At a sub-step 254(c), similar to the sub-step 241(c), the media reader 146 obtains the media content key 128 from the license 133.

At a sub-step 254(d), similar to the sub-step 241(d), the media reader 146 checks the license 133 for any restrictions it can enforce (such as for example a restriction to a selected time window), and if it finds any, enforces them. For one example, not intended to be limiting in any way, the media reader 146 might check that the license 133 is in fact issued with regard to the specific media (such as an individual DVD-Video), in which case the media reader 146 might compute a hash code for the specific media and compare it with a designated hash code in the license 133. This might have the effect that the media reader 146 generates a signal indicating that the license 133 is not currently valid, and in one embodiment, why. If the license 133 is not currently valid, the media reader 146 refuses to ingest the physical media 147. If the license 133 is currently valid, the media reader 146 continues with the next sub-step.

At a sub-step 254(e), similar to the sub-step 241(e), the media reader 146 decrypts any digital content on the physical media 147 using the media content key 128 (if in fact that physical media 147 was encrypted to start with; if not, no decryption is performed), and re-encrypts that digital content with a new media content key 128. This has the effect of generating inert content 122, which the media reader 146 sends to the local content library 142.

At a step 255, the local content library 142 maintains the inert content 122 in storage 121.

At a flow point 250B, the user subsystem 140 has ingested physical media 147 using a media reader 146, and is ready to do something else.

Alternative Embodiments

Although preferred embodiments are disclosed herein, many variations are possible which remain within the concept, scope, and spirit of the invention. These variations would become clear to those skilled in the art after perusal of this application.

The invention is not restricted to movies, but is also applicable to other media streams, such as for example animation or sound, as well as to still media, such as for example pictures or illustrations, and to databases and other collections of information.

Those skilled in the art will recognize, after perusal of this application, that these alternative embodiments are illustrative and in no way limiting.

1. A method, including steps of
delivering, to a user, digital content representing at least a portion of a media stream, the digital content being locked against inspection or tampering by that user;
separately delivering, to that user, a license including a content key capable of unlocking that digital content, the content key being locked against inspection or tampering by devices other than a selected presentation device owned by that user;
wherein the selected presentation device is associated with a presentation device key, a secure portion of the presentation device being capable of unlocking the license using the presentation device key;
whereby that user is restricted to presentation of that media stream at the selected presentation device.

2. A method as in claim 1, including steps of
reading at least a portion of the digital content from physical media;
encrypting that portion read from physical media using a content key;
whereby the user is restricted to have a license for presentation of the digital content read from physical media.

3. A method as in claim 1, wherein at least a portion of the locked digital content is delivered to the user using at least one of: (a) a communication link, or (b) physical media from which the digital content can be read.

4. A method as in claim 1, wherein at least a portion of the locked digital content is maintained by the user for possible delivery to more than one such presentation device.

5. A method as in claim 1, wherein at least a portion of the license is delivered to the user using at least one of: (a) a communication link, or (b) physical media from which the digital content can be read.

6. A method as in claim 1, wherein the digital content is locked using a form of encryption and the content key is associated with decryption of that digital content.

7. A method as in claim 1, wherein the media stream includes at least one of: animation or sound, still media, pictures or illustrations, a database, another collection of information.

8. A method as in claim 1, wherein the digital content includes at least some information capable of inspection by the user other than for presentation of the media stream.

9. A method as in claim 8, wherein that information capable of inspection includes information about the media stream, including at least one of: (a) a title, (b) a film clip, (c) a summary, (d) a set of information associated with the author, actors, genre, or rating of the media stream.

10. A method as in claim 8, wherein that information capable of inspection includes metadata about the media stream.

11. A method as in claim 1, wherein the license imposes restrictions on presentation of that media stream.

12. A method as in claim 11, wherein the restrictions include at least one of: (a) a first date or time at which presentation is allowed for the media stream, (b) a last date or time at which presentation is allowed for the media stream, (c) a limited number of presentations allowed for the media stream, (d) a limited physical region at which presentation is allowed for the media stream, (e) a charge, cost, fee, or subscription associated with allowing presentation of the media stream, (f) a type of presentation device, (g) an output format used by the presentation device, (h) a bit rate, sampling rate, or other measure of granularity or precision used by the presentation device.

13. A method as in claim 11, wherein the license is capable of being renewed or revoked.

14. A method as in claim 11, wherein the license includes an integrity code capable of revealing whether that license has been tampered with.

15. A method as in claim 1, wherein that secure portion of the presentation device includes elements relatively resistant to intrusion on any of their communication paths and not allowing the presentation device key, the content key, or the digital content to be inspected or tampered with.
